(19) United States
(12) Patent Application Publication
(10) Pub. No.: US 2017/0116562 A1
(43) Pub. Date: Apr. 27, 2017

(54) SYSTEMS AND METHODS FOR CUSTOMER-TO-CUSTOMER PRODUCT DELIVERY

(71) Applicant: Facebook, Inc., Menlo Park, CA (US)

(72) Inventors: Bryan J. Schroeder, El Dorado Hills, CA (US); Stephen Richard Biddle, Oak Park, IL (US); Mark Harrison Link, Hoboken, NJ (US); Katherine B. Thomas, New York, NY (US); Kimberly Ann Wiley, Atlanta, GA (US)

(21) Appl. No.: 14/924,485

(22) Filed: Oct. 27, 2015

(51) Int. Cl. G06Q 10/08; H04L 29/08

(52) U.S. Cl. CPC G06Q 10/083; H04L 67/306

(57) ABSTRACT

Systems, methods, and non-transitory computer-readable media can receive delivery order information associated with a delivery order made by a remote customer with a merchant. Notification of an in-store customer available to make deliveries is received. The in-store customer is assigned to the delivery order.

### FIELD OF THE INVENTION

The present technology relates to the field of social networks. More particularly, the present technology relates to computer techniques for supporting customer-to-customer product delivery.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

User experience associated with a social networking system can be enhanced as the social networking system becomes more knowledgeable about the users that it serves. Potentially helpful knowledge about the user can include profile information about the user as well as the user's activity on the social network. When knowledge of a user is gained, content, advertising, and other services can be optimized and offered to the user, including content and services within the social networking system as well as outside the social networking system.

### SUMMARY

Various embodiments of the present disclosure can include systems, methods, and non-transitory computer readable media configured to receive delivery order information associated with a delivery order made by a remote customer with a merchant. A notification is received of an in-store customer available to make deliveries. The in-store customer is assigned to the delivery order.

In an embodiment, notification is received of a second in-store customer available to make deliveries, and it is determined that the second in-store customer should not be assigned to the delivery order.

In an embodiment, a communication is initiated between the remote customer and at least one of: the merchant, the in-store customer, or a social networking system, after the in-store customer is assigned to the delivery order.

In an embodiment, the communication is supported by a communication platform implemented by a social networking system.

In an embodiment, the communication is terminated once the delivery order has been delivered.

In an embodiment, the delivery order information comprises a delivery address and product information.

In an embodiment, the delivery order information is maintained by a social networking system.

In an embodiment, confirmation is received that the delivery order has been delivered to the remote customer.

In an embodiment, the in-store customer is provided with a reward based on receiving confirmation that the delivery order has been delivered to the remote customer.

In an embodiment, the reward comprises a credit that may be used with the merchant.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example product delivery module, according to an embodiment of the present disclosure.

FIG. 2 illustrates an example interface module, according to an embodiment of the present disclosure.

FIG. 3 illustrates an example courier determination module, according to an embodiment of the present disclosure.

FIG. 4 illustrates an example method for customer-to-customer product delivery, according to an embodiment of the present disclosure.

FIG. 5 illustrates an example method to assign an in-store customer to a delivery order, according to an embodiment of the present disclosure.

FIG. 6 illustrates an example method to rank potential in-store customer couriers, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Customer-to-Customer Delivery Fulfillment

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system. Users also can consider and complete transactions using their computing devices. For example, it is becoming more and more common for users to utilize computing devices to make purchases of goods to be delivered to the user.

As a user utilizes and interacts on a social networking system, the system receives and stores more information about a user and learns more about the user. The profile and interactions of the user as well as the profile and interactions of connections of the user can provide important information about the user. For example, interactions on a social networking system can provide information about the user's life outside the social networking system. Information regarding such interactions can be leveraged by the social networking system to optimize the presentation of relevant content, advertising, and other services to the user to enhance the user's experience.

Despite the availability of such information, it continues to be a challenge for social networking systems rooted in computer technology to utilize that information to provide content and services that are of interest to users. Such information, when available, can be used to connect users to other users in their community and provide related services to benefit the community as a whole, as well as users as individuals. For example, such information can be used in various manners to facilitate purchases of goods sought by a user. However, the sheer magnitude of information maintained by the social networking system can render retrieval of such information by a user difficult or cumbersome. Further, attempts by the social networking system to automatically retrieve and present relevant information for the user can result in a large volume of available information that could overwhelm the user.

Therefore, an improved approach can be beneficial for overcoming disadvantages associated with conventional approaches or improving conventional approaches. Based on computer technology, the disclosed technology can provide customer-to-customer product delivery by allowing in-store customers to pick up delivery orders at a merchant (i.e., on or near a location, premises, or establishment where the merchant conducts business) and make deliveries to remote customers. User social network interaction information, along with other available information, can be utilized to determine in-store customers at the merchant who live nearby a remote user and are available to pick up and deliver a delivery order to the remote user. Further information may be utilized to rank and filter potential in-store customer couriers to ensure secure delivery of the delivery order. Available information may also be utilized to rank and filter delivery opportunities, for example, to ensure the safety of the in-store customer courier. Once successful delivery is confirmed, in-store customer couriers may be rewarded for their services.

The various systems and methods disclosed herein allow for various benefits in addition to those already discussed. For example, environmental benefits may be obtained based on the ability to deliver products for multiple customers (e.g., an in-store customer and a remote customer) in a single trip to a merchant. Furthermore, growing numbers of customers making purchases remotely, rather than in store, means that fewer products need to be packaged for display in a store. As the prevalence of remote purchasing grows, products may be placed in packaging that is not “shelf-ready” which can save in packaging materials and costs (e.g., placing cereal in a single plastic bag, rather than a plastic bag within a cardboard box that can stand on shelves). Also, the combination of a merchant ecommerce system with a social networking system's information and infrastructure may allow users to make repeated purchases easily, and may allow a social networking system or merchant to utilize user purchase information to reach out to users with marketing messages based on their behavior.

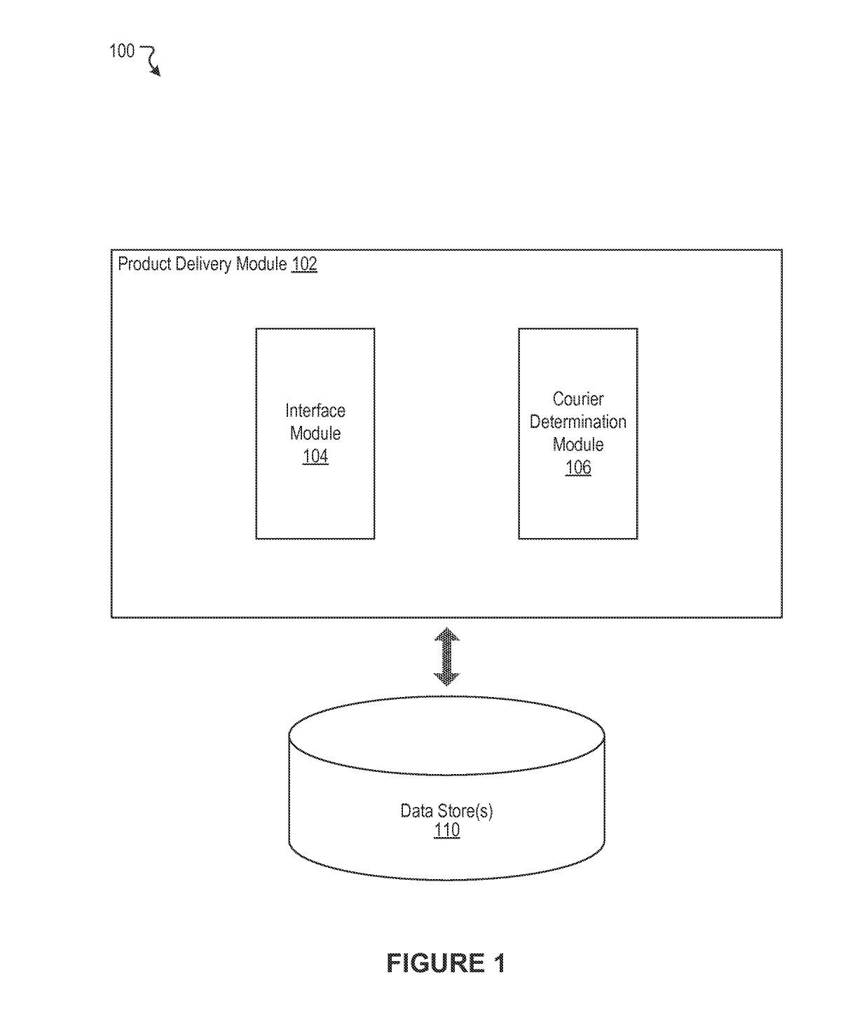

FIG. 1 illustrates an example system 100 including an example product delivery module 102 configured to facilitate customer-to-customer product delivery, according to an embodiment of the present disclosure. The product delivery module 102 can be configured to receive delivery order information for one or more delivery orders. In one embodiment, each delivery order may be made by a remote user with a merchant for delivery to a delivery address. In certain embodiments, delivery order information may be transmitted to and/or maintained by a social networking system. The term “remote user”, as used herein, can include any user who has made a delivery order with a merchant. Once delivery order information has been received, the product delivery module 102 may be configured to identify one or more in-store customers at the merchant who are available to deliver the delivery order to the remote user. In-store customers may include customers who are at the merchant to do their own shopping (for example, users who are at the merchant to do their weekly grocery shopping), or may include users who are at the merchant specifically for the purpose of making deliveries to remote users. Each in-store customer represents a potential in-store customer courier for the delivery order.

The product delivery module 102 can be configured to assign an in-store customer to each delivery order based on various criteria, including courier qualification criteria and/or delivery qualification criteria. The product delivery module 102 can be further configured to track the delivery order and/or initiate communications with the in-store customer courier once they have left the merchant to ensure secure delivery of the delivery order to the remote user.

In certain embodiments, rather than assigning an in-store customer to each delivery order, the product delivery module 102 may be configured to provide the merchant with a listing of qualified in-store customers. Such a listing can be used to allow the merchant to assign in-store customer couriers to each delivery order. These features are discussed in greater detail herein.

As shown in the example of FIG. 1, the product delivery module 102 can include an interface module 104 and a courier determination module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The interface module 104 can be configured to facilitate communications and data transfer between the parties of a customer-to-customer delivery system, such as remote users, in-store customers, merchants, and a social networking system, to ensure safe and secure customer-to-customer delivery of delivery orders. For example, the interface module 104 may be configured to interface with a remote customer and/or a merchant to receive delivery order information (e.g., delivery address, product information). The interface module 104 can also be configured to interface with one or more in-store customers to determine who is currently shopping at the merchant. This information may then be used to determine an available pool of in-store customers. Information collected by the interface module 104 may then be used by the courier determination module 106 to assign an in-store customer as an in-store customer courier for each delivery order, as discussed in greater detail herein.

After an in-store customer courier has been assigned to a delivery order, the interface module 104 can be configured to facilitate communications and data transfer between the parties (e.g., remote user, in-store customer courier, merchant, social networking system) to ensure safe delivery of the delivery order. The interface module 104 is discussed in greater detail herein.

The courier determination module 106 can be configured to assign an in-store customer courier to each delivery order. The courier determination module 106 can receive information about available delivery orders and potential in-store customer couriers, and determine an appropriate in-store customer courier for each delivery order based on various factors. For example, these factors can include courier qualification criteria. These factors can also include delivery qualification criteria. The courier determination module 106 is discussed in greater detail herein.

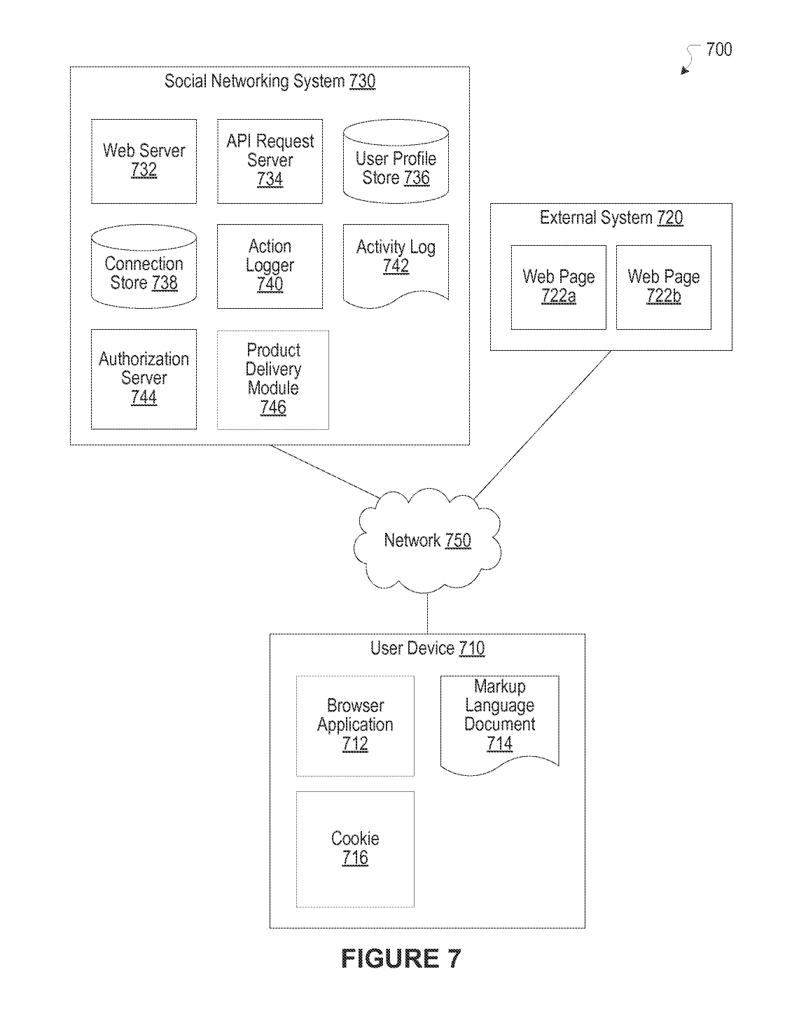

The product delivery module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the product delivery module 102 can be implemented, in part or in whole, as software running on one or more computing devices or systems, such as on a server computing system or a user (or client) computing system. For example, the product delivery module 102 or at least a portion thereof can be implemented as or within an application (e.g., app), a program, or an applet, etc., running on a user computing device or a client computing system, such as the user device 710 of FIG. 7. In another example, the product delivery module 102 or at least a portion thereof can be implemented using one or more computing devices or systems that include one or more servers, such as network servers or cloud servers. In some instances, the product delivery module 102 can, in part or in whole, be implemented within or configured to operate in conjunction with a social networking system (or service), such as the social networking system 730 of FIG. 7. It should be understood that there can be many variations or other possibilities.

The product delivery module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the product delivery module 102. For instance, the data store 110 can store user address and user location information, user purchase history information, user social graph and connection information, courier delivery performance history information, remote user delivery history information, and any other information that may be used to carry out the present technology disclosed herein. It is contemplated that there can be many variations or other possibilities.

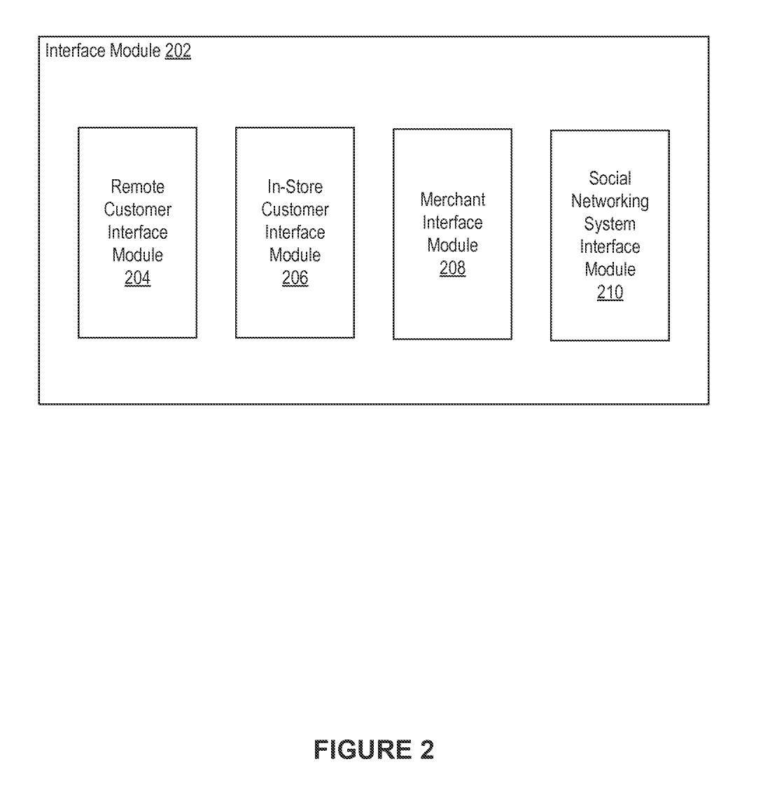

FIG. 2 illustrates an example interface module 202 configured to facilitate communications and data transfer between parties to facilitate secure customer-to-customer delivery of a delivery order, according to an embodiment of the present disclosure. In some embodiments, the interface module 104 of FIG. 1 can be implemented as the example interface module 202. As shown in FIG. 2, the interface module 202 can include a remote customer interface module 204, an in-store customer interface module 206, a merchant interface module 208, and a social networking system interface module 210. The interface module 202 can implement a user interface displayed on a computing device associated with a remote customer, a merchant, an in-store customer courier, or other party to receive and provide information from and to the party for management of customer-to-customer delivery of a delivery order in accordance with the present technology. The user interface for each type of party can be designed to provide functionality tailored to and supportive of the particular role, actions, and preferences of each party in customer-to-customer delivery of a delivery order. Features of the user interfaces for the parties are described in more detail and in connection with the modules of the product delivery module 102, as set forth herein. For example, when functionality, features, or actions (e.g., setting of preferences, delivery of notifications, delivery of messages, notification of availability, selection of options, transmission of delivery orders, etc.) are described herein, it should be appreciated that the functionality, features, and actions are implemented or supported by an appropriate user interface.

The remote customer interface module 204 can be configured to facilitate communications and data transfer between a remote customer and other parties involved in customer-to-customer product delivery, such as a merchant, an in-store customer courier, or a social networking system. For example, the remote customer interface module 204 may facilitate communications and data transfer between the remote customer and a merchant, such that the remote customer can place a delivery order with the merchant. The delivery order may include certain delivery order information, such as payment information, a billing address, a delivery address, product information identifying one or more products being ordered by the remote customer, and the like.

The remote customer interface module 204 may allow a remote customer to specify user preferences that may be applied to delivery orders. In certain embodiments, the remote customer user preferences may allow the remote customer to specify courier qualification criteria. For example, the remote customer can specify various courier qualification criteria to ensure the reliability and trustworthiness of any in-store customer courier that is assigned to deliver the remote user's delivery order.

One example of courier qualification criteria can include the ability to limit in-store customer couriers based on social graph information, such as limiting in-store customer couriers to only connections of the remote user on a social networking system, or certain connections of connections (e.g., “friends of friends” within a selected number of degrees of separation) on the social networking system. The qualification criteria may be implemented by using information available to the social networking system and/or the merchant. By limiting in-store customer couriers to people who are in some way connected to the remote customer, the remote customer may be provided with reassurance that product delivery will be performed with reliability and security.

Another example of courier qualification criteria can include the ability to limit in-store customer couriers to people who live within a pre-determined radius from the remote customer's home address or another delivery address. Other courier qualification criteria may also be specified by a merchant or a social networking system to ensure reliable and safe use of a customer-to-customer product delivery system. Examples of additional courier qualification criteria will be discussed in greater detail herein.

The remote customer interface module 204 may also allow the user to rate or review his or her delivery experience with a particular in-store customer courier. In certain embodiments, in-store customer couriers may be associated with a courier rating that is indicative of the courier's performance history in making customer-to-customer deliveries. Remote customers who have received a delivery from an in-store customer courier may be given the option to assign the in-store customer courier a rating based on the remote customer's experience. The rating may be as simple as a “thumbs up” or a “thumbs down,” in which case the courier rating can comprise a cumulative number of thumbs up and thumbs down received by the courier, or a percentage of positive reviews out of total reviews received. Alternatively, the rating may be more granular, giving remote users the ability to rate each in-store customer courier on a scale (e.g., 1-5 stars) and possibly to give ratings in a variety of categories (e.g., timeliness, appearance, condition of delivery, communication).

The courier rating may be utilized as part of the courier qualification criteria discussed above. For example, a remote customer may be able to specify a courier rating threshold that must be satisfied for in-store costumers to be assigned to the remote customer's delivery order. The courier rating threshold can be one of a variety of values, such as only in-store customer couriers with at least fifty successful deliveries, a positive experience rate greater than 70%, a rating of greater than 4 stars, etc.

The in-store customer interface module 206 can be configured to facilitate communications and data transfer between an in-store customer and other parties involved in customer-to-customer product delivery, such as a merchant, a remote customer, and a social networking system. In certain embodiments, the in-store customer interface module 206 may be configured to allow an in-store customer to notify the merchant and/or the social networking system when the in-store customer is at the merchant or within a threshold distance from the premises of the merchant and available to make deliveries. Notification of the in-store customer's availability may be carried out in various ways. In one example, the in-store customer can “check-in” at the merchant with an indication that the in-store customer is willing to deliver delivery orders. In addition, the in-store customer's presence at the merchant may be determined automatically. For example, geo-location information provided by a user mobile device may be used to automatically determine that the in-store customer is at the merchant. In another example, location detection techniques and related equipment at the merchant may be able to automatically determine a customer's identity when the customer enters the merchant's store. An example of a location detection technique can include Bluetooth or NFC between the customer's mobile device and a receiver at the merchant which identifies the customer to the merchant.

In certain embodiments, an in-store customer may set a delivery availability preference. For example, when the delivery availability preference is set to a first setting, the in-store customer notifies the merchant and/or the social networking system that he or she is available to make deliveries. When the delivery availability preference is set to a second setting, the in-store customer has opted not to notify the merchant or the social networking system that he or she is available to make deliveries.

Once an in-store customer leaves the merchant or is not located within a threshold distance from the premises of the merchant, another notification may be provided indicating that the in-store customer is no longer available for deliveries. If an in-store customer courier leaves the merchant with a delivery order for a remote customer, a notification may be sent to the remote customer that the delivery order has left the merchant and is on its way. An estimated time of delivery may also be provided to the remote customer.

Similar to the courier qualification criteria discussed above, the in-store customer interface module 206 may be configured to receive delivery qualification criteria from an in-store customer. The delivery qualification criteria may then be considered when assigning the in-store customer to any delivery orders. For example, much like couriers may be assigned a courier rating, each remote customer may be assigned a remote customer rating indicative of past couriers' experiences with respect to delivering orders to the remote customer. This remote customer rating may take into account various factors, such as the safety of the delivery address location, ease of delivery, how responsive or communicative the remote customer was, availability of the remote customer to receive delivery, etc. Similar to the way the remote customer was able to specify a courier rating threshold, the in-store customer interface module 206 may permit the in-store customer to specify a delivery rating threshold in order for the in-store customer to be assigned to a particular delivery order for delivery.

Another example of delivery qualification criteria can include the ability to limit remote customers based on social graph information. For example, a criterion may specify that the remote customer associated with the delivery order must be a connection or a connection of a connection on a social networking system (e.g., only make deliveries to friends or friends of friends).

Delivery qualification criteria can also include a geographic limitation, such as a maximum distance threshold. For example, the in-store customer can specify that the delivery address must be within a certain number of miles from the in-store customer's home, the merchant, or another address specified by the in-store customer. In this way, the in-store customer can ensure that he or she will not have to go very far out of the way to make the delivery.

Yet another example of delivery qualification criteria may include product-based limitations. For example, an in-store customer may not be willing or able to take a product based on the dimensions of the product (e.g., the product is too large to fit in the in-store customer's car), the product's value (e.g., the in-store customer is unwilling to take delivery orders that are too valuable), or other attributes of the product (e.g., product noxiousness, place of manufacture, etc.).

The in-store customer interface module 206 may also be configured to provide a notification to other parties involved in customer-to-customer product delivery that a delivery has been completed. In certain embodiments, the in-store customer courier may take some action to notify the parties of successful delivery. In other embodiments, the remote customer may provide notification of successful delivery via the remote customer interface module 204. Notification of successful delivery may be carried out in a variety of ways. For example, the delivery orders may be placed in tamper-free packaging by the merchant. If the delivery order is delivered without any evidence of tampering, then the remote customer can indicate that the delivery order is delivered via his or her mobile device. Alternatively, if the remote customer is not available to accept the package, the in-store customer courier can upload a photograph of the delivered, unopened package at the delivery address. Geo-tagging information associated with the photograph may be used to ensure that the photograph was taken at the delivery address. In certain embodiments, the in-store customer courier may be blocked from marking a delivery order as completed unless the in-store customer courier is currently at the delivery address, or was previously at the delivery address. This can be detected by tracking the in-store customer courier's location, for example, using location information from the in-store customer courier's mobile device.

The merchant interface module 208 can be configured to facilitate communications and data transfer between a merchant and various parties involved in customer-to-customer product delivery. For example, the merchant interface module 208 may allow a merchant to communicate with a social networking system to transmit or receive delivery order information or to receive a list of in-store customers available for delivery. Similarly, the merchant interface module 208 may allow a merchant to communicate with a remote customer, for example, to provide an update that the delivery order has left the merchant or with an in-store customer, for example, to notify the in-store customer that they have been assigned a delivery order that is ready to be picked up and delivered. The various communications and transfers of data involving the merchant described herein (e.g., notification of a delivery order, notification of in-store customers available to makes deliveries, notification of completed delivery orders) may be carried out via interaction of the merchant interface module 208 with other modules disclosed herein.

In certain embodiments, once a delivery has been completed, in-store customer couriers may be provided a reward for successful delivery of the delivery order. For example, the in-store customer courier may receive a gift card or store credit in exchange for their services as a courier. The merchant interface module 208 may be configured to credit an account associated with the in-store customer courier. For example, the merchant interface module 208 can credit the in-store customer courier's credit card or credit a gift card account associated with the in-store customer courier.

The social network system interface module 210 can be configured to facilitate communications and data transfer between a social networking system and any other parties involved in customer-to-customer product delivery (e.g., remote customers, in-store customers, merchants, etc.) The social network system interface module 210 may allow various parties to make use of information available to the social network system, such as social graph information and user address and user location information, to name some examples. For example, the social network system interface module 210 may allow the social networking system to notify a merchant of in-store customers who have checked in at the merchant on the social networking system. In another example, social graph information may be used to apply courier qualification criteria or delivery qualification criteria based on social graph information, as described herein.

In certain embodiments, the social networking system may have infrastructure and interfaces in place to facilitate communications between parties via the social networking system's infrastructure. For example, a communications platform on the social networking system (e.g., a messaging application) may be used to allow a remote customer and an in-store customer courier to communicate with one another, for example, to arrange for delivery of a delivery order. In certain embodiments, a communication may be initiated between a remote customer and an in-store customer courier when the in-store customer courier departs the merchant with the remote customer's delivery order. In order to protect the privacy and security of the various parties, the communication may be terminated once the delivery order has been successfully delivered. In certain embodiments, user information may be concealed to protect the privacy of users. For example, users may be identified only by pseudonyms and/or abbreviated names. The social networking system's infrastructure may also be utilized to provide delivery confirmation communications to the merchant and/or the remote user.

It should be appreciated that the various communications and transfers of data described above may be carried out in a variety of ways. In one example, a messenger application on a social networking system may be used to facilitate communications between the various parties. In addition, other communications mediums such as SMS, email, or the like may be utilized.

Furthermore, although various communications and transfers of data may be described herein as coming from a particular source or delivered to particular destination, it should be understood that these descriptions are examples only, and may be altered in various way while still remaining within the scope of the present disclosure. For example, any of the communications described above as being made by or to a merchant may instead be made by or to a social networking system when, for example, the social networking system functions as a merchant, functions as a portal to a merchant, or acts on behalf of a merchant. In another example, notification of an in-store customer's availability to make deliveries may be provided by the in-store customer to the social networking system, and then the social networking system to the merchant, or, alternatively, from the in-store customer to the merchant and then from the merchant to the social networking system, or, in another embodiment, directly from the in-store customer to both the social networking system and the merchant, etc.

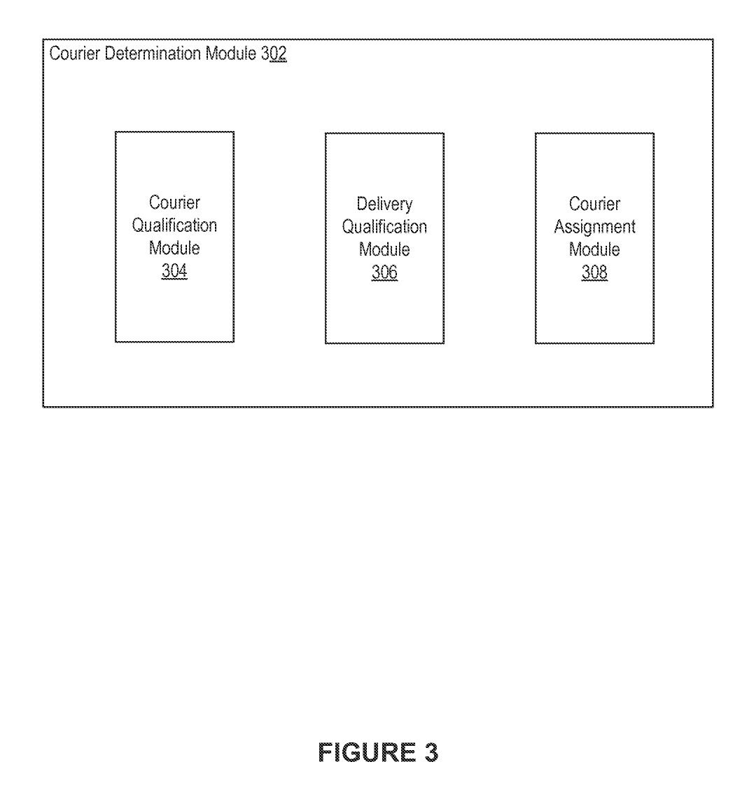

FIG. 3 illustrates an example courier determination module 302 configured to assign an in-store customer courier to a delivery order, in accordance with an embodiment of the present disclosure. In some embodiments, the courier determination module 106 of FIG. 1 may be implemented as the example courier determination module 302. As shown in FIG. 3, the courier determination module 302 can include a courier qualification module 304, a delivery qualification module 306, and a courier assignment module 308.

The courier qualification module 304 can be configured to determine one or more in-store customers available to make deliveries, and to determine which of the one or more available in-store customers satisfy a set of courier qualification criteria. Certain courier qualification criteria may be used to filter out and remove certain potential in-store customer couriers (i.e., courier filtering criteria). Certain courier qualification criteria may be used to rank and prioritize potential in-store customer couriers (i.e., courier ranking criteria). As discussed above, courier qualification criteria may be specified by a remote customer, or may also be specified by other parties, such as a social networking system or a merchant. The courier qualification criteria may be used to filter out and/or rank in-store customers as potential in-store customer couriers for a particular delivery order.

As mentioned above, a social networking system and a merchant may be able to specify courier qualification criteria. The social networking system and the merchant may have an interest in specifying courier qualification criteria to ensure that customers who utilize customer-to-customer delivery have a positive experience utilizing the service. For example, the social networking system or the merchant may apply courier qualification criteria to ensure that a potential in-store customer courier is trustworthy and has a lower likelihood of inappropriate behavior. Some examples of courier qualification criteria that may be used to ensure a threshold level of trustworthiness can include whether a potential in-store customer courier has a minimum number of connections, whether the potential in-store customer courier's profile on a social networking system has existed for a minimum period of time, whether the potential in-store customer courier has posted a minimum number of posts on the social networking system, etc. Safety and reliability may be further supported by specifying certain informational requirements from each potential in-store customer courier. The requirements may include the required availability of driver's license information, insurance information, home address, credit card information, car make and model, license plate, etc.

The courier qualification module 304 may gather any relevant courier qualification criteria specified by the social networking system, the merchant, and the remote customer, and apply it to the available in-store customers to determine whether there are any in-store customers who satisfy all of the courier qualification criteria.

The courier qualification module 304 may also be configured to rank the available in-store customers based on the courier qualification criteria. The courier qualification criteria may include not only criteria that can be used to filter out potential couriers (i.e., courier filtering criteria), but also criteria that can be used to rank potential couriers (i.e., courier ranking criteria). For example, various factors that may be considered in ranking potential in-store customer couriers can include: proximity of an in-store customer's home address to the delivery address (i.e., the higher the proximity, the higher the in-store customer's ranking); the number of connections in common between the in-store customer and the remote customer (i.e., the higher the number, the higher the in-store customer's ranking); the number of successful deliveries made by the in-store customer (i.e., the higher the number, the higher the ranking); the in-store customer's courier rating (i.e., the higher the in-store customer's courier rating, the higher the ranking), and the like.

A list of available in-store customers that have been filtered and ranked based on the courier qualification criteria may then be passed to the courier assignment module 308 for assignment of in-store customers to delivery orders. In certain embodiments, the list of filtered and ranked in-store customers may be sent to the merchant for the merchant to assign in-store customers to delivery orders. In other embodiments, assignment of in-store customer couriers to deliveries may be performed by a social networking system, or an application that is independent of the merchant and the social networking system.

Similar to the courier qualification module 304, the delivery qualification module 306 can be configured to determine one or more delivery orders that are available for delivery, and to filter and rank the one or more delivery orders based on delivery qualification criteria. As discussed herein, each in-store customer can specify delivery qualification criteria that must be satisfied by a delivery order in order to assign that in-store customer to the delivery order. For each in-store customer, the delivery qualification module 306 may remove any delivery orders that do not satisfy the in-store customer's delivery qualification criteria. Delivery qualification criteria may also be specified by the merchant or the social networking system, in which case the delivery qualification module 306 can also apply any relevant delivery qualification criteria specified by the social networking system or the merchant.

Furthermore, in certain embodiments, the delivery qualification criteria may also include criteria not only for filtering out delivery orders (i.e., delivery filtering criteria), but also for ranking them (i.e., delivery ranking criteria). For example, delivery orders may be ranked based on proximity to the in-store customer's home address, a delivery rating associated with the remote customer, a safety rating associated with the delivery address, and the like.

The courier assignment module 308 can be configured to assign an in-store customer courier to a delivery order based on the courier qualification criteria applied by the courier qualification module 304 and the delivery qualification criteria applied by the delivery qualification module 306.

In certain embodiments, in-store customers may be presented with a list of available and ranked delivery orders (1) for which the in-store customer satisfies all courier qualification criteria, and (2) which satisfy the in-store customer's delivery qualification criteria. Each delivery order may include relevant information about the delivery order, so that the in-store customer can select one or more delivery orders that he or she wishes to accept and deliver.

In one embodiment, the filtering functions performed by the courier qualification module 304 and the delivery qualification module 306 may be performed after the in-store customer has selected a delivery order to accept. For example, if the in-store customer attempts to accept a delivery order for which the in-store customer does not satisfy all courier qualification criteria, then the in-store customer may be informed that they are not permitted to accept that delivery order. Or if the in-store customer attempts to accept a delivery order for which the in-store customer's delivery qualification criteria have not been satisfied, the in-store customer may be provided with a warning and then be asked if they would like to accept the delivery order anyway. In another embodiment, in-store customers may be automatically assigned to one or more delivery orders so long as the delivery orders satisfy the delivery qualification criteria and the in-store customer satisfies the courier qualification criteria.

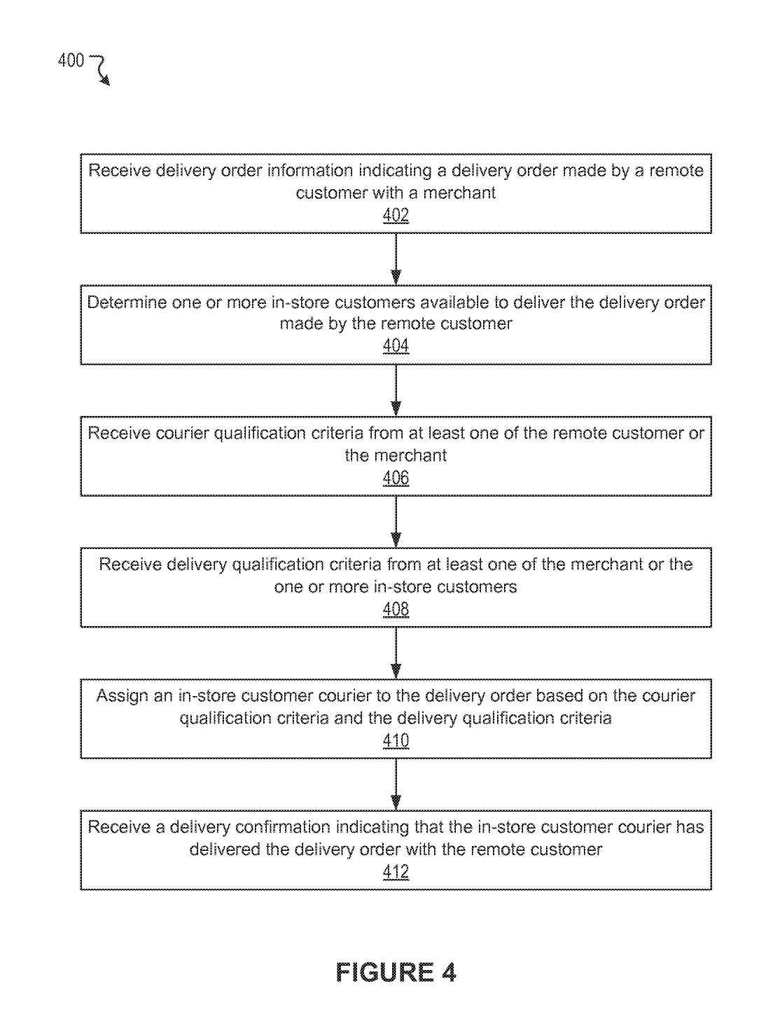

FIG. 4 illustrates an example method 400 associated with providing customer-to-customer product delivery, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can receive delivery order information indicating a delivery order made by a remote customer with a merchant. At block 404, the example method 400 can determine one or more in-store customers available to deliver the delivery order made by the remote customer. At block 406, the example method 400 can receive courier qualification criteria from at least one of the remote customer or the merchant. At block 408, the example method 400 can receive delivery qualification criteria from at least one of the merchant or the one or more in-store customers. At block 410, the example method 400 can assign an in-store customer courier to the delivery order based on the courier qualification criteria and the delivery qualification criteria. At block 412, the example method 400 can receive a delivery confirmation indicating that the in-store customer courier has delivered the delivery order with the remote customer.

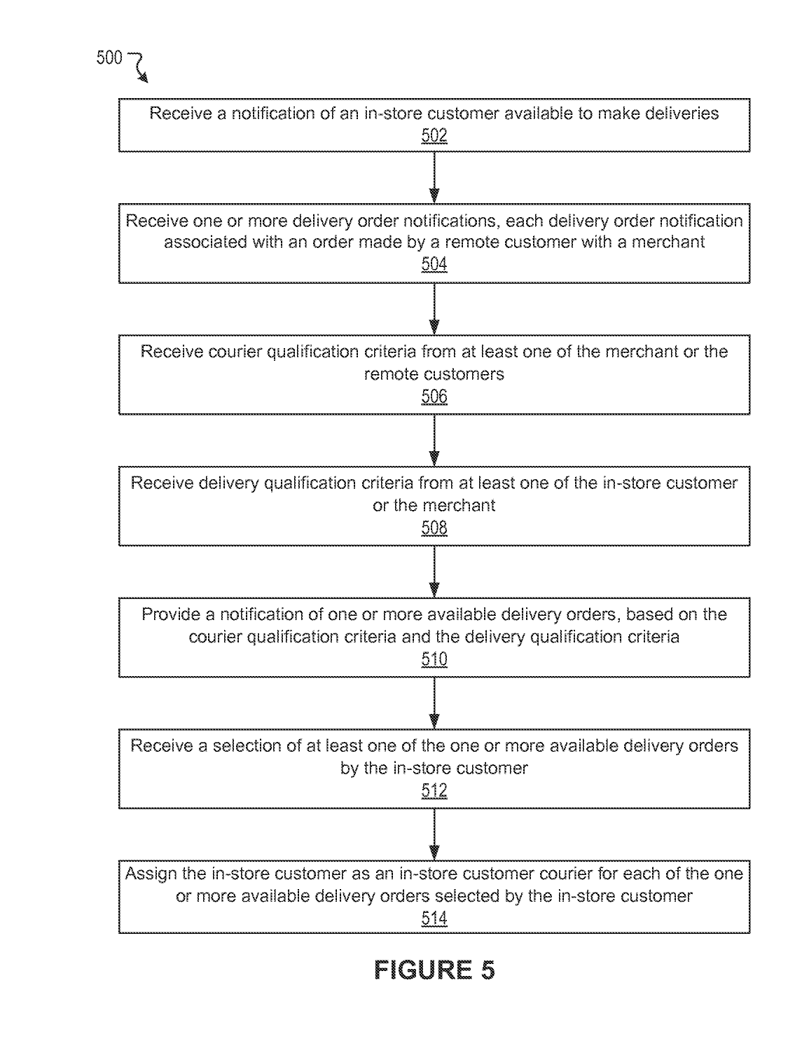

FIG. 5 illustrates an example method 500 associated with assigning and in-store customer to a delivery order, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can receive a notification of an in-store customer available to make deliveries. At block 504, the example method 500 can receive one or more delivery order notifications, each delivery order notification associated with an order made by a remote customer with a merchant. At block 506, the example method 500 can receive courier qualification criteria from at least one of the merchant or the remote customers. At block 508, the example method 500 can receive delivery qualification criteria from at least one of the in-store customer or the merchant. At block 510, the example method 500 can provide a notification of one or more available delivery orders, based on the courier qualification criteria and the delivery qualification criteria. At block 512, the example method 500 can receive a selection of at least one of the one or more available delivery orders by the in-store customer. At block 514, the example method 500 can assign the in-store customer as an in-store customer courier for each of the one or more available delivery orders selected by the in-store customer.

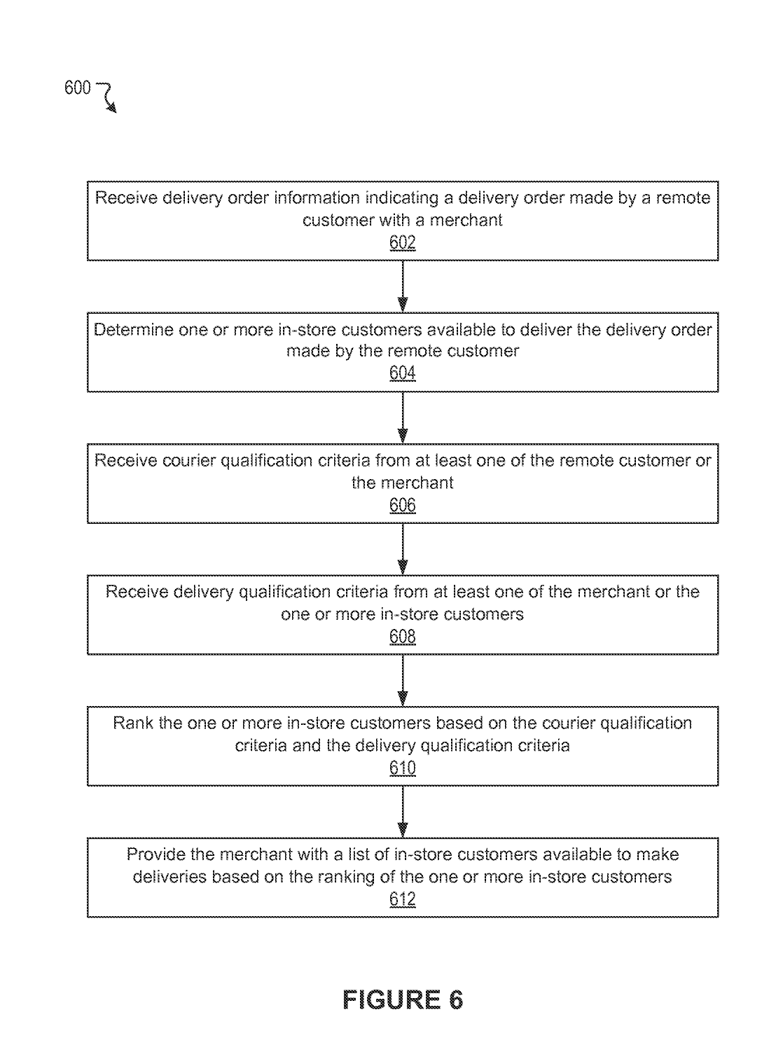

FIG. 6 illustrates an example method 600 associated with ranking one or more potential in-store customer couriers, according to an embodiment of the present disclosure. It should be appreciated that there can be additional, fewer, or alternative steps performed in similar or alternative orders, or in parallel, based on the various features and embodiments discussed herein unless otherwise stated.

At block 602, the example method 600 can receive delivery order information indicating a delivery order made by a remote customer with a merchant. At block 604, the example method 600 can determine one or more in-store customers available to deliver the delivery order made by the remote customers. At block 606, the example method 600 can receive courier qualification criteria from at least one of the remote customer or the merchant. At block 608, the example method 600 can receive delivery qualification criteria from at least one of the merchant or the one or more in-store customers. At block 610, the example method 600 can rank the one or more in-store customers based on the courier qualification criteria and the delivery qualification criteria. At block 612, the example method 600 can provide the merchant with a list of in-store customers available to make deliveries based on the ranking of the one or more in-store customers.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user may be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This can occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a product delivery module 746. The product delivery module 746 can, for example, be implemented as the product delivery module 102 of FIG. 1. As discussed previously, it should be appreciated that there can be many variations or other possibilities. For example, in some instances, the product delivery module 746 (or at least a portion thereof) can be included or implemented in the user device 710. Other features of the product delivery module 746 are discussed herein in connection with the product delivery module 102.

### Hardware Implementation

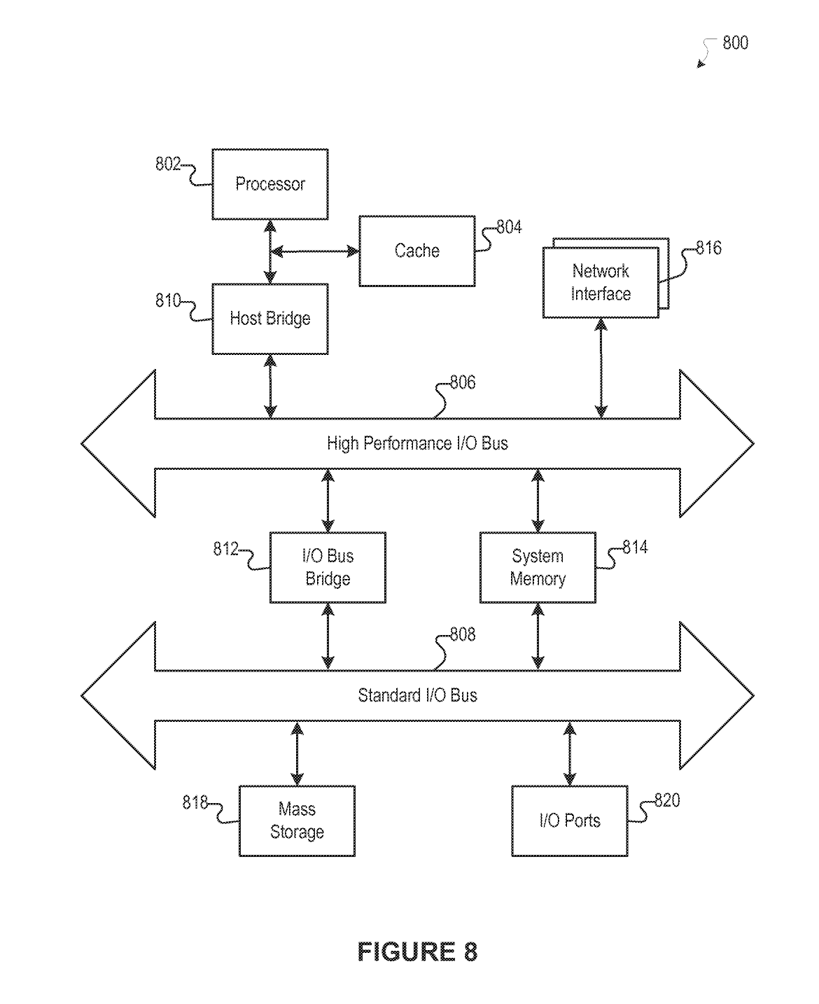

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, delivery order information associated with a delivery order made by a remote customer with a merchant;
receiving, by the computing system, notification of an in-store customer available to make deliveries; and
assigning, by the computing system, the in-store customer to the delivery order.

2. The computer-implemented method of claim 1, further comprising:
receiving notification of a second in-store customer available to make deliveries; and
determining that the second in-store customer should not be assigned to the delivery order.

3. The computer-implemented method of claim 1, further comprising initiating a communication between the remote customer and at least one of the merchant, the in-store customer, or a social networking system, after the in-store customer is assigned to the delivery order.

4. The computer-implemented method of claim 3, wherein the communication is supported by a communication platform implemented by a social networking system.

5. The computer-implemented method of claim 3, further comprising terminating the communication once the delivery order has been delivered.

6. The computer-implemented method of claim 1, wherein the delivery order information comprises a delivery address and product information.

7. The computer-implemented method of claim 6, wherein the delivery order information is maintained by a social networking system.

8. The computer-implemented method of claim 1, further comprising receiving confirmation that the delivery order has been delivered to the remote customer.

9. The computer-implemented method of claim 8, further comprising providing the in-store customer with a reward based on the receiving confirmation that the delivery order has been delivered to the remote customer.

10. The computer-implemented method of claim 9, wherein the reward comprises a credit that may be used with the merchant.

11. A system comprising:
at least one processor; and
a memory storing instructions that, when executed by the at least one processor, cause the system to perform:
receiving delivery order information associated with a delivery order made by a remote customer with a merchant;
receiving notification of an in-store customer available to make deliveries; and
assigning the in-store customer to the delivery order.

12. The system of claim 11, wherein the method further comprises:
receiving notification of a second in-store customer available to make deliveries; and
determining that the second in-store customer should not be assigned to the delivery order.

13. The system of claim 11, wherein the method further comprises initiating a communication between the remote customer and at least one of: the merchant, the in-store customer, or a social networking system, once the in-store customer is assigned to the delivery order.

14. The system of claim 13, wherein the communication is supported by a communication platform implemented by a social networking system.

15. The system of claim 13, wherein the method further comprises terminating the communication once the delivery order has been delivered.

16. A non-transitory computer-readable storage medium including instructions that, when executed by at least one processor of a computing system, cause the computing system to perform a method comprising:
receiving delivery order information associated with a delivery order made by a remote customer with a merchant;
receiving notification of an in-store customer available to make deliveries; and
assigning the in-store customer to the delivery order.

17. The non-transitory computer-readable storage medium of claim 16, wherein the method further comprises:
receiving notification of a second in-store customer available to make deliveries; and
determining that the second in-store customer should not be assigned to the delivery order.

18. The non-transitory computer-readable storage medium of claim 16, wherein the method further comprises initiating a communication between the remote customer and at least one of: the merchant, the in-store customer, or a social networking system, once the in-store customer is assigned to the delivery order.

19. The non-transitory computer-readable storage medium of claim 18, wherein the communication is supported by a communication platform implemented by a social networking system.

20. The non-transitory computer-readable storage medium of claim 18, wherein the method further comprises terminating the communication once the delivery order has been delivered.
